(19) United States
(12) Patent Application Publication
(10) Pub. No.: US 2015/0326949 A1
(43) Pub. Date: Nov. 12, 2015

(54) DISPLAY OF DATA OF EXTERNAL SYSTEMS IN SUBTITLES OF A MULTI-MEDIA SYSTEM

(71) Applicant: International Business Machines Corporation, Armonk, NY (US)

(72) Inventors: Peter H. Burton, Vancouver (CA); Manvendra Gupta, Brampton (CA); Helena Litani, Vaughan (CA)

(73) Assignee: International Business Machines Corporation, Armonk, NY (US)

(21) Appl. No.: 14/274,830

(22) Filed: May 12, 2014

(51) Int. Cl. H04N 21/81; G10L 15/26; H04N 7/088

(52) U.S. Cl. CPC H04N 21/8133; H04N 7/0882; G10L 15/265

(57) ABSTRACT

A computer-implemented method for displaying data from external computing systems in subtitles of a multi-media system is provided. The computer-implemented method comprises analyzing data of an incoming media stream from at least one external computing system, wherein the data is analyzed to identify at least one of a text-based data, a voice-based data, or a video-based data of the least one external computing system that is associated with the multi-media system. The computer-implemented method further comprises augmenting at least one subtitle of the multi-media system with the identified and converted at least one of the text-based data, the voice-based data, or the video-based data. The computer-implemented method further comprises generating at least one annotation of the multi-media system with the identified and converted at least one of the text-based data, the voice-based data, or the video-based data.

### BACKGROUND

The present invention relates generally to multi-media systems, and more particularly to display of data of external systems in subtitles of a multi-media system.

Among visual, audio and textual information present in a video sequence, provides condensed information that aids in viewing, and understanding video content for an end-user of a system of the video sequence. Textual presentation of information, thus, plays an important role in browsing and retrieving video data of the video sequence. Also, subtitles can be presented in text of condensed information of the video sequence. For example, subtitles are textual versions of a dialog, or commentary in films, television programs, or video games. Subtitles are typically displayed at the bottom of a screen of the video sequence.

### SUMMARY

In one embodiment, a computer-implemented method for displaying data from external computing systems in subtitles of a multi-media system is provided. The computer-implemented method comprises, analyzing, by one or more processors, data of an incoming media stream from at least one external computing system, wherein the data is analyzed to identify at least one of a text-based data, a voice-based data, or a video-based data of the least one external computing system that is associated with a multi-media system. The computer-implemented method further comprises performing, by the one or more processors, voice to text conversion of the identified at least one of the text-based data, the voice-based data, or the video-based data. The computer-implemented method further comprises identifying, by the one or more processors, media content of at least one of the text-based data, the voice-based data, or the video-based data, during the voice to text conversion, wherein media content is converted to uniform resource identifiers. The computer-implemented method further comprises augmenting, by the one or more processors, at least one subtitle of the multi-media system with the identified and converted at least one of the text-based data, the voice-based data, or the video-based data. The computer-implemented method further comprises generating, by the one or more processors, at least one annotation of the multi-media system with the identified and converted at least one of the text-based data, the voice-based data, or the video-based data.

In another embodiment, a computer system for displaying data from external computing systems in subtitles of a multi-media system is provided. The computer system comprises one or more processors, one or more computer-readable memories, one or more computer-readable tangible storage devices and program instructions which are stored on at least one of the one or more storage devices for execution by at least one of the one or more processors via at least one of the one or more memories. The computer system further comprises program instructions to analyze data of an incoming media stream from at least one external computing system, wherein the data is analyzed to identify at least one of a text-based data, a voice-based data, or a video-based data of the least one external computing system that is associated with a multi-media system. The computer system further comprises program instructions to perform voice to text conversion of the identified at least one of the text-based data, the voice-based data, or the video-based data. The computer system further comprises program instructions to identify media content of at least one of the text-based data, the voice-based data, or the video-based data, during the voice to text conversion, wherein media content is converted to uniform resource identifiers. The computer system further comprises program instructions to augment at least one subtitle of the multi-media system with the identified and converted at least one of the text-based data, the voice-based data, or the video-based data. The computer system further comprises program instructions to generate at least one annotation of the multi-media system with the identified and converted at least one of the text-based data, the voice-based data, or the video-based data.

In yet another embodiment, a computer program product for displaying data from external computing systems in subtitles of a multi-media system, is provided. The computer program product comprises one or more computer-readable tangible storage devices and program instructions stored on at least one of the one or more storage devices. The computer program product further comprises, program instructions to analyze data of an incoming media stream from at least one external computing system, wherein the data is analyzed to identify at least one of a text-based data, a voice-based data, or a video-based data of the least one external computing system that is associated with a multi-media system. The computer program product further comprises program instructions to perform voice to text conversion of the identified at least one of the text-based data, the voice-based data, or the video-based data. The computer program product further comprises program instructions to identify media content of at least one of the text-based data, the voice-based data, or the video-based data, during the voice to text conversion, wherein media content is converted to uniform resource identifiers. The computer program product further comprises program instructions to augment at least one subtitle of the multi-media system with the identified and converted at least one of the text-based data, the voice-based data, or the video-based data. The computer program product further comprises program instructions to generate at least one annotation of the multi-media system with the identified and converted at least one of the text-based data, the voice-based data, or the video-based data.

Viewed from a further aspect, the present invention provides a computer program product for displaying data from external computing systems in subtitles of a multi-media system, the computer program product comprising a computer readable storage medium readable by a processing circuit and storing instructions for execution by the processing circuit for performing a method for performing the steps of the invention.

Viewed from yet another aspect, the present invention provides a computer program stored on a computer readable medium and loadable into the internal memory of a digital computer, comprising software code portions, when said program is run on a computer, for performing the steps of the invention.

### BRIEF DESCRIPTION OF THE SEVERAL VIEWS OF THE DRAWINGS

Novel characteristics of the invention are set forth in the appended claims. The invention will best be understood by reference to the following detailed description of the invention when read in conjunction with the accompanying figures, wherein like reference numerals indicate like components, and:

FIG. 1 is a functional block diagram of a multi-media system for analyzing data of incoming media stream, including, for example, data of social media sources of at least one external computing system and, displaying the analyzed data of the at least one external computing system, in subtitles of multi-media system, in accordance with embodiments of the present invention.

FIG. 2 is a functional block diagram illustrating program components of a central media server system, in accordance with embodiments of the present invention.

FIGS. 3A-3D illustrates program components of a multi-media computing device, in accordance with embodiments of the present invention.

FIG. 4 is a flow diagram depicting steps performed by a central media server system for analyzing data of incoming media stream and, displaying the analyzed data of the at least one external computing system, in subtitles of multi-media system, in accordance with embodiments of the present invention.

FIG. 5 illustrates a block diagram of components of a computer system, in accordance with embodiments of the present invention.

### DETAILED DESCRIPTION

Subtitles, or captions are textual versions of communication, including, for example, text, audio, still images, animation, video, interactivity content forms, or commentary, in movies, television programs, and other media, that are typically displayed at the bottom of a screen of a multi-media system.

Subtitles can also address accessibility, or ease of understanding, for deaf and, hard of hearing, by displaying dialog of various communications in the multi-media system. However, a drawback of subtitles is limited display of information, from external sources, in subtitles, including, for example, limited display of information in subtitles, from external electronic news providers, social media share sites, entities, companies, or the World Wide Web, in general. The present invention provides a system for analyzing, within a media environment, monitored, and detected data of incoming media stream from at least one external computing system, wherein, according to at least one embodiment, the analyzed monitored, and detected data of the incoming media stream is displayed in subtitles of a multi-media system.

For instance, the analyzed data is metadata, including, for example, identified and, extracted tags of media content of a text-based data, a voice-based data, or a video-based data of the incoming media stream. The system also extracts additional media content of the text-based data, the voice-based data, or the video-based data, and correlates the extracted additional media content with the initially analyzed metadata of the text-based data, the voice-based data, or the video-based data, for the purpose of further extending, terms, keywords, or topics, discussed, identified, detected, or monitored in media content of the incoming media stream, that are associated with the real-time, streaming media of the multi-media device. The metadata also includes, for example, detected data of social media sources, dictionaries, news media sources, or other external media sources, that are included in the text-based data, the voice-based data, or the video-based data of the incoming media stream of the external computing system.

The metadata of the incoming media stream can also include graphical logos, or representation of entities, companies, products, etc. For example, a video based data, or a voice-based data of the incoming media stream includes detected streaming voice logo of an entity, or a company, wherein the detected streaming voice logo is identified by the system as a graphical logo of the entity or company, and wherein the identified graphical logo is displayed, in the subtitle, as a clickable uniform resource identifiers (URIs). The clickable URI can either be directly linked to a website of the entity, or the company, or even to a product, or offering of the entity, or the company.

According to at least one aspect, the system further performs a voice to text conversion of the text-based data, the voice-based data, or the video-based data of the incoming media stream. During the voice to text conversion, the system identifies media content of the text-based data, the voice-based data, or the video-based data of the incoming media stream, wherein the identified and, converted media content is further converted to uniform resource identifiers (URIs), for display of the URIs, as clickable, or accessible URIs, displayed in the subtitles of the multi-media device. For example, the system augments the subtitles of the multi-media device with the identified and converted text-based data, the voice-based data, or the video-based data of the incoming media stream. The augmentation of the subtitles is a textual display, or a visual display of the identified and, converted text-based data, voice-based data, or video-based data of the incoming media stream, in the subtitles. The textual display or visual display is presented, in descriptions of the subtitles in the multi-media device.

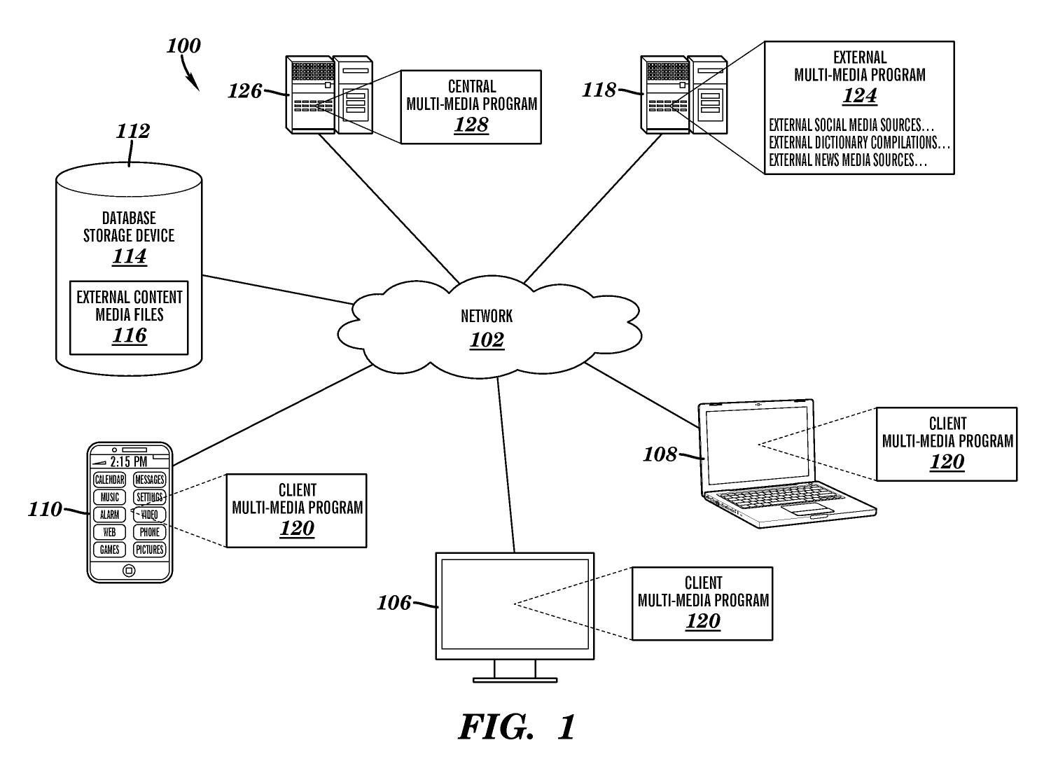

The present invention will now be described in detail with reference to the accompanying Figures. Referring now to FIG. 1, multi-media system 100 for analyzing data of incoming media stream, including, for example, data of social media sources of at least one external computing system and, displaying the analyzed data of the at least one external computing system, in subtitles of multi-media system 100, is shown. In this description, the terms “graphic”, “image”, “media”, “display”, “presentation” are all used interchangeably to refer to signal that is displayed across one or more display units, or subtitles of multi-media system 100. For example, according to at least one aspect of the invention, a signal may encode a wide range of graphic data, including, for example, a range of graphical data that displayed in subtitles of a movie, media photograph, presentation, live broadcast, or other multi-media display systems.

Multi-media system 100 includes client multi-media computing devices 106, 108, 110, external media server system 118, database storage 114 and, central media server system 126, all interconnected over network 102. Multi-media computing devices 106, 108, 110, external media server system 118, database storage 114 and, central media server system 126, operate over network 102 to facilitate generation and, display of subtitles of multi-media computing devices 106, 108, 110, based on monitored, and detected data of incoming media stream from external media server system 118.

Multi-media computing devices 106, 108, 110 are media communication devices, or media systems that are adapted to display subtitles, or captions of multi-media content, from external media server system 118. Multi-media computing devices 106, 108, 110, can also be broadcast television communication devices that provide encoding, or formatting standards for transmission of media content.

Multi-media computing devices 106, 108, 110 can also be laptops, tablets, notebook personal computers (PC), desktop computers, mainframe, mini computers, or personal digital assistants (PDA). Multi-media computing devices 106, 108, 110 can also be any portable device that provides computing and, information storage, and retrieval capabilities, including, for example, a handheld device or handheld computer, pocket PC, connected organizer, electronic book (eBook) reader, a personal digital assistant (PDA), or a smart phone, or other mobile portable devices.

Each one of multi-media computing devices 106, 108, 110 includes client multi-media program 120. Client multi-media program 120 is a streaming media communication program that displays information in subtitles of multi-media computing devices 106, 108, 110. The streaming media communication program is typically delivered by central media server system 126 to multi-media computing devices 106, 108, 110, for presentation of the streaming media communication program to an end-user of multi-media computing devices 106, 108, 110.

Client multi-media program 120 can also receive and, present, streaming media communications, in multi-media computing devices 106, 108, 110, via radio frequency (RF) signals transmitted through coaxial cables or light pulses through fiber-optic cables. Client multi-media program 120 can also provide on-line, or internet access to a variety of media information sources, such as, media note books, media periodicals, media content images, media video clips, and media scientific data, for display in client multi-media program 120, from external media server system 118, in accordance with embodiments of the present invention.

Central media server system 126 can be, a central media mainframe server system, such as, a media management server, a media web server, or any other transmitting electronic device, or central computing server system that is capable of receiving and sending media content, or serving as an intersection for analyzing data of an incoming media stream from external media server system 118 and, also, transmitting the analyzed data of the incoming media stream to multi-media computing devices 106, 108, 110, for display of the transmitted analyzed data, in subtitles of multi-media computing devices 106, 108, 110. Central media server system 126 also includes application programs for transporting, delivering network media services of the analyzed data of the incoming media stream. Central media server system 126 can also be connected, via network 102, to storage subsystems, including, for example, database storage device 114, or storage and data organization schemes of multi-media system 100, for supporting retrieving and, transmitting the incoming stream of multi-media content from external media server system 118.

Central media server system 126 includes central multi-media program 128. Central multi-media program 128 receives multi-media content of incoming media stream from external media server system 118, and analyzes data of the incoming media stream of external computing systems to identify at least one of a text based data, a voice based data, or a video based data of the incoming media stream that is associated with a streaming media module of multi-media computing devices 106, 108, 110. Central multi-media program 128 stores the analyzed data for retrieval in database storage device 114, wherein the data is retrieved and, analyzed by central multi-media program 128, for transmittal of the analyzed data to central multi-media program 128. For example, according to at least one embodiment, the transmitted, analyzed data is displayed, in subtitles or captions of multi-media computing devices 106, 108, 110.

Database storage device 114 is any type of storage device, storage server, storage area network, redundant array of independent discs (RAID), cloud storage service, or any type of data storage that stores data of the incoming media stream, in external content media files 116, from external media server system 118. Determination of whether the stored media stream is transmitted to multi-media computing devices 106, 108, 110, by central multi-media program 128, is based on whether the media stream is associated with the streaming media module of multi-media computing devices 106, 110, 112.

The incoming media stream is associated with the streaming media module of multi-media computing devices 106, 108, 110, if the incoming stream includes the same, or similar media content of the a text based data, a voice based data, or a video based data of the real-time streaming media module of multi-media computing devices 106, 108, 110. Central multi-media program 128 monitors, and detects, stored incoming media stream content of the analyzed data, periodically, randomly, and/or using event-based to determine with the media stream is associated with the streaming media module of multi-media computing devices 106, 110, 112.

External media server system 118 is a mainframe server system, such as an external management media server, an external web media server, or any other electronic device, or external computing server system that is capable of receiving and, sending data of media stream, including, data of external media broadcasts of multi-media system 100, including, for example, external social media sources, external dictionaries compilations, external news media sources, or other external media sources of multi-media content. External media server system 118 includes external multi-media program 124, which transmits the incoming media stream to central multi-media program 128, periodically, randomly, and/or using event-based transmittal of the incoming media stream, for display of the incoming media stream, in subtitles of multi-media computing devices 106, 108, 110, in accordance with embodiments of the present invention.

Network 102 includes one or more networks of any kind that can provide communication links between various devices and computers connected together within multi-media system 100. Network 102 can also include connections, such as wired communication links, wireless communication links, or fiber optic cables. Network 102 can also be implemented as a number of different types of networks, including, for example, a local area network (LAN), wide area network (WAN) or a packet switched telephone network (PSTN), or some other networked system.

Multi-media system 100 utilizes the Internet with network 102 representing a worldwide collection of networks. The term “Internet” as used according to embodiments of the present invention, refers to a network or networks that uses certain protocols, such as the TCP/IP protocol, and possibly other protocols such as the hypertext transfer protocol (HTTP) for hypertext markup language (HTML) documents that make up the world wide Web (the web).

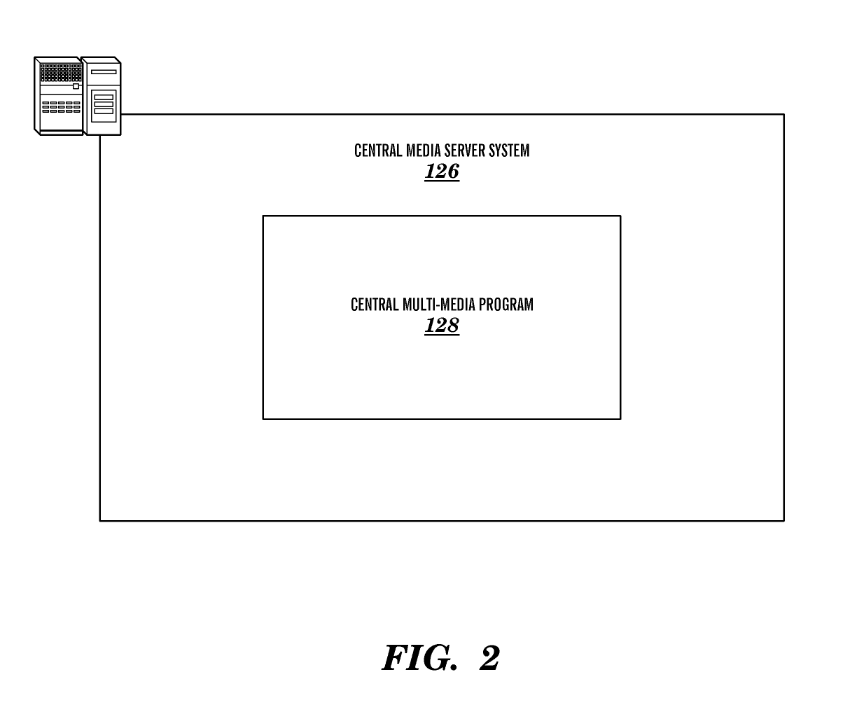

FIG. 2 is a functional block diagram illustrating program components of central media server system 126, in accordance with embodiments of the present invention. Central multi-media program 128 can, among other things, retrieve, and transmit incoming data of multi-media content, from external media server system 118, for display of the incoming data in client multi-media program 120, in accordance with embodiments of the present invention. Central multi-media program 128 monitors, and analyzes data of incoming media stream of external media server system 118, to identify at least one of a text based data, a voice based data, or a video based data of the incoming media stream that is associated with a streaming media module of client multi-media program 120.

Central multi-media program 128 monitors the incoming media stream, periodically, randomly, and/or using event-based monitoring of the incoming media stream to determine whether the incoming media stream is associated with the streaming media module of multi-media computing devices 106, 110, 112. For instance, if the incoming media stream is associated with the streaming media module of client multi-media program 120, central multi-media program 128 extracts tags, including, for instance, keywords, or terms of media content that are assigned to the text based data, the voice based data, or the video based data of both the incoming media stream of the external media computing devices, and the media stream of the computing devices 106, 110, 112. For example, a video based data, or a voice-based data of the incoming media stream that includes, detected streaming voice logo of the entity or company, the detected streaming voice logo is converted, transmitted, during the voice to text conversation, and displayed, in the multi-media system, as a clickable URI to an end-user of the multi-media system. The clickable URI could either be directly to a website of, for example, the entity, or the company, or even to a product, or offering of the entity, or the company.

Central multi-media program 128 stores, in database storage device 114, time, date, and geographical location of the extracted tags of keywords, or terms of media content that are assigned to the text based data, the voice based data, or the video based data of the incoming media stream of external media server system 118, wherein, the recorded time, date, and geographical location of the extracted tags of keywords, includes searchable data including, media content of data of incoming media stream of external media server system 118. The recorded time, date, and geographical location, can also represent, for example, recording time, or recording date of text, video, or voice of the incoming media stream, includes, a date the video of the incoming media stream was created, or uploaded in external media server system 118, or geography location of the upload incoming media stream of external media server system 118.

Central multi-media program 128 also identifies media content of the text-based data, the voice-based data, or the video-based data, during the voice to text conversion, wherein media content is converted to uniform resource identifiers (URIs), by central multi-media program 128. For example, during voice-to-text, central multi-media program 128 identifies keywords and, phrases of the media content, which are automatically converted to the URIs, for display in subtitles multi-media computing devices 106, 110, 112.

Central multi-media program 128 also augments subtitles of multi-media computing devices 106, 108, 110, with the identified and, converted text-based data, the voice-based data, or the video-based data of the incoming media stream. The augmentation of the subtitles is a text display or a visual display of the identified and converted text-based data, voice-based data, or video-based data of the incoming media stream. For example, the text display or visual display is presented, in descriptions of the subtitles in client multi-media program 120.

Central multi-media program 128 further generates at least one annotation of the identified and converted text-based data, voice-based data, or video-based data of the incoming media stream. The analyzed data of incoming media stream includes, detected data of social media sources, dictionaries, news media sources, or other external media sources, which are included in the text-based data, the voice-based data, or the video-based data of the incoming media stream of external media server system 118. The subtitles of the multi-media system and the generated annotation of the multi-media system are transmitted to multi-media computing devices 106, 110, 112, for display of the analyzed data in subtitles of client multi-media program 120.

Database storage device 114 stores the monitored and, analyzed data of the incoming media stream of external media computing system 118, in external content media files, based on a taxonomy database management scheme of database storage device 114. The taxonomy database management scheme can, for example, organize the stored data of incoming media stream of external media server system 118 based on categories, or subcategories of data classifications. Central multi-media program 128, also stores, augments, and optimizes common taxonomies of the incoming media stream of data that are associated with the media content of multi-media computing devices 106, 108, 110.

The taxonomy database management scheme can also represent, geography taxonomy including, country, language, city, year, headlines of the monitored and analyzed data of the incoming media stream of external media computing system 118. The taxonomy can also represent, for example, movie taxonomy, including, movie, actor, director, genre, producer, studio, writer, country, reviews, year, awards, news articles of the incoming media stream of data. Central multi-media program 128 further performs voice to text conversion of the identified text-based data, the voice-based data, or the video-based data of the incoming media stream of external computing devices.

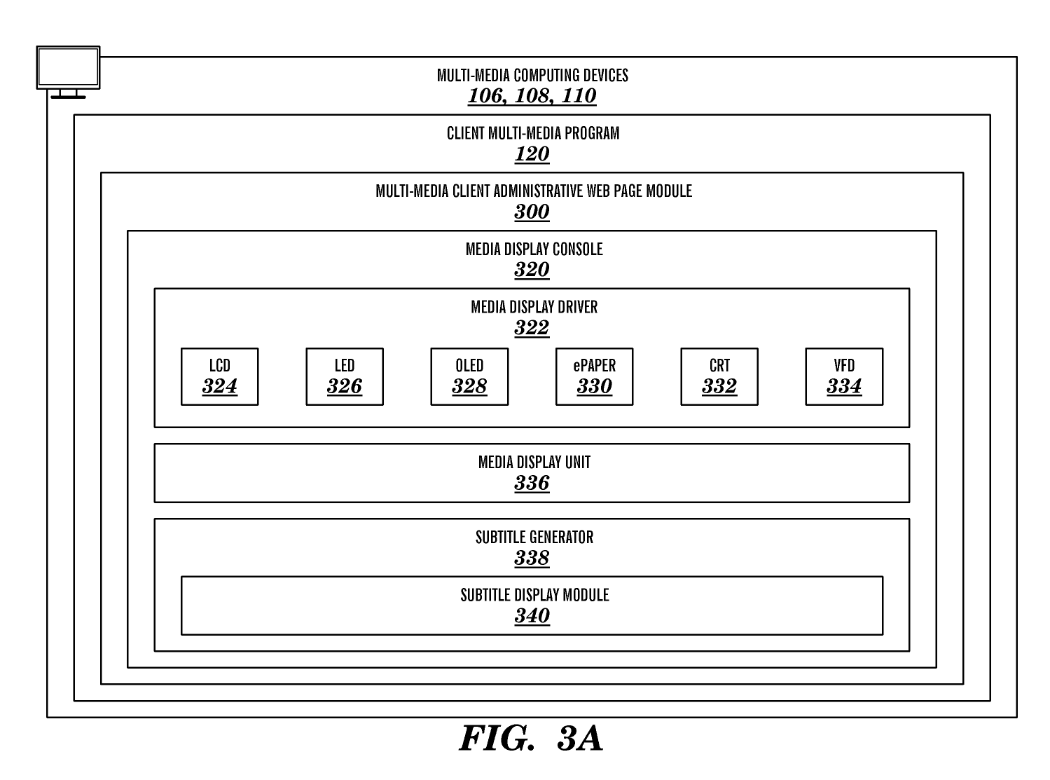

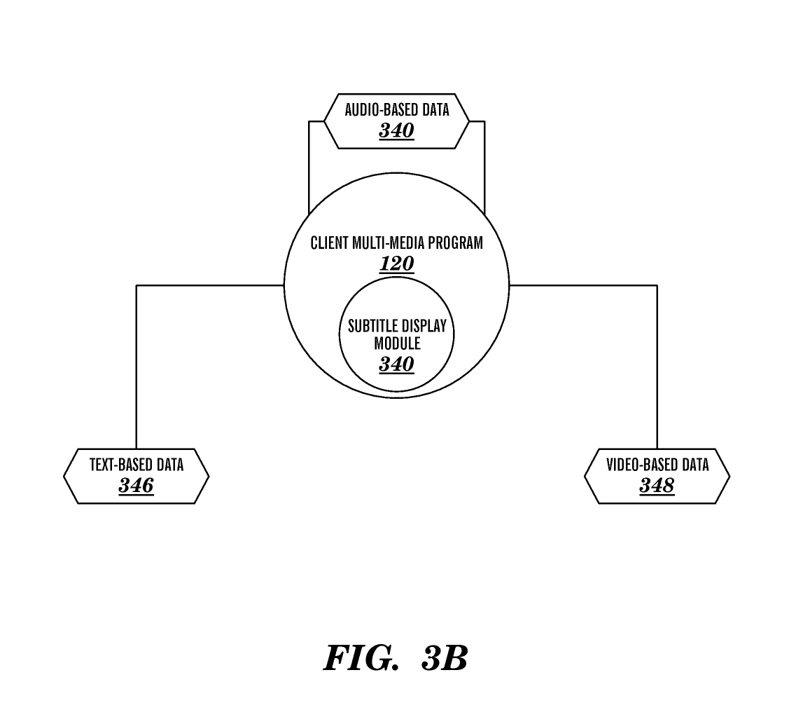

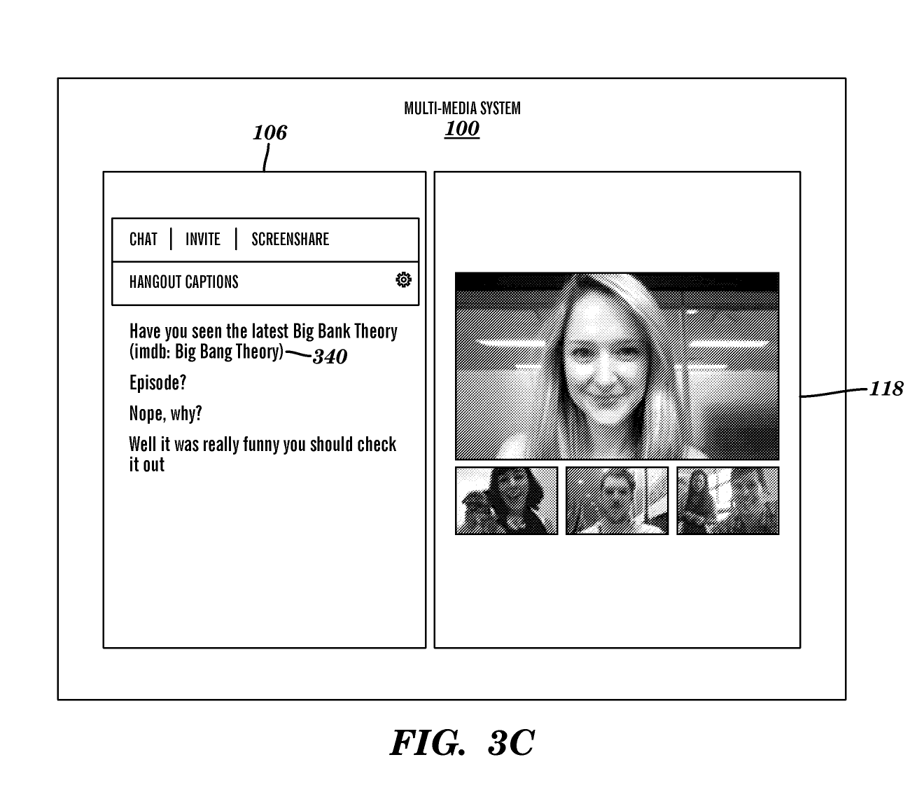

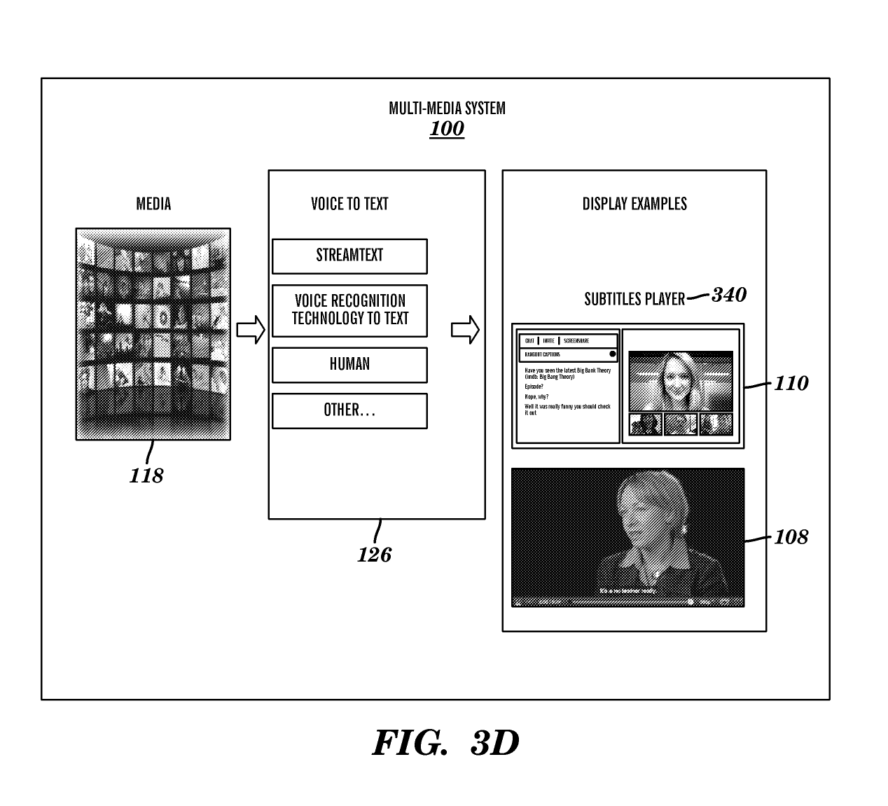

FIG. 3A is a functional block diagram illustrating program components of multi-media computing devices 106, 108, 110, in accordance with embodiments of the present invention. Client multi-media program 120 receives, in real-time, monitored, and detected, analyzed data of incoming media stream of media content from central multi-media program 128. As described, the analyzed data is metadata, including, for example, identified tags of media content of a text-based data, a voice-based data, or a video-based data of the incoming media stream of media content.

Client multi-media program 120 displays the received analyzed data of central multi-media program 128, in a client media display unit, to an end-user, or client of central multi-media program 128. Client multi-media program 120 program can be, for example, a web media client browser system application for receiving, and displaying the analyzed data of incoming media stream of media content from multi-media server program. Client multi-media program 120 includes multi-media client administrative web page module 300. Multi-Media client administrative web page module 300 is a media display unit, or a media web page browser plug-in/add-on display unit that extends the functionality of client multi-media program 120, by adding additional user interface elements to client multi-media program 120.

Multi-Media client administrative web page module 300 includes media display console 320, which is received in media client administrative web page module 300 from central multi-media program 128, for providing a client interface for displaying subtitles of media contents to an en-user, or client multi-media program 120. Media display console 320 includes program code, such as, Hypertext Markup Language (HTML) code or JavaScript code that, when executed, adds one or more user interface elements to multi-media program for displaying media contents of to the end user, or client.

Media display console 320 also supports operations of various multi-media operating system applications, including, for example, multi-media management programs, multi-media video compression programs, multi-media process scheduling applications, or other multi-media system application programs that support display of media contents in client multi-media program 120. Media display console 320 is also adapted to support display of streaming audio, video, games, or editors, which can be utilized by client multi-media program 120 to display a text-based data, a voice-based data, or a video-based data of the incoming media stream in subtitles of client multi-media program 120.

Media display console 320 further includes media display driver 322, media display unit 336, and subtitle generator 338. Media display driver 322 is communicatively coupled to media display unit 336 for transmitting display of media contents of a general-purpose peripheral multi-media interface of multi-media computing devices 106, 108, 110. For example, according to at least one embodiment, media display driver 322 provides an interface function between a general-purpose peripheral interface of media display console 320 and display devices, e.g. liquid-crystal display (LCD) 324, light-emitting diode (LED) 326, OLED (organic light-emitting diode) 328, ePaper 330, cathode ray tube (CRT) 332, and vacuum fluorescent display (VFD) 334, for transmitting the display of media contents of the general-purpose peripheral multi-media interface.

Media display module 320 identifies hardware profile data of the general-purpose peripheral interface that is associated with media display driver 322, and creates media display settings in multi-media computing devices 106, 108, 110, via client multi-media program 120, based on the identified hardware profile. Media display unit 336 also provides application support of multi-media content display, in media display console 322, for displaying the incoming media stream of media content of video media contents, and audio media contents, in subtitles of media display unit 322, all within the general-purpose peripheral interface.

Subtitle generator 338 generates captions of the incoming media stream of media content of video media contents, and audio media contents, of external multi-media program 124, for display in subtitle display module 340, to an end user, or client of client multi-media program 120, in accordance with embodiments of the present invention.

FIG. 3B is a functional block diagram illustrating interaction of media contents in client multi-media program 120, wherein, client multi-media program 120 displays incoming media stream of media content, including, video media contents, and/or audio media contents, in subtitle display module 340 of client multi-media program 120, in accordance with embodiments of the present invention.

Audio-based data 340 is an electrical or other representation of sound of streaming, or incoming stream of media content, from external multi-media program 124, conveyed to an end-user in subtitle display module 340. Audio-based data 340 can also be a representation of audible content in media production, and publishing of the media production in client multi-media program 120, which is processed, and conveyed, in subtitle display module 340, by a general-purpose peripheral interface of media display console 320, in accordance with embodiments of the present invention.

Text-based data 346 is a translation, or natural language of audio-based data 340. Client multi-media program 120 includes a speech recognition module that provides conversion of spoken words of audio-based data 340 of the streaming, or incoming stream of media content of external multi-media program 124, into text, for display in subtitles of client multi-media program 120. For instance, the speech recognition module can be an automatic speech recognition program of client multi-media program 120 that is monitored periodically, randomly, and/or using event-based monitoring, by client multi-media program 120, for converting the spoken words of audio of the streaming, or incoming stream of media content, into text.

Video-based data 348 is an electronic medium for the recording, copying and broadcasting moving visual images of streaming, or incoming stream of media content, from external multi-media program 124, for display in to an end user, or client of subtitle display module 340. Video-based data 348 can also be a compression, or graphics, displayed in the streaming, or incoming stream of media content. Also, roles of converting audio to text, text to audio, audio to image, or image to audio, for display, or conveyance in subtitle display module 340, are interchangeable.

FIG. 3C is a functional block diagram illustrating interaction of subtitle display of incoming stream of media content in client multi-media program 120, all within multi-media system 100, wherein the incoming media stream of multi-media system is converted to text-based data 346, audio-based data 340, and video-based data 348, for display in subtitle display module 340.

In the depicted embodiment, end users of client multi-media program 120 are engaged in a video chat session of multi-media system 100. During the video chat session, end-users mention “Big Bank theory”. For example, “Big Bank theory” is identified and, detected, by central multi-media program 128, as an incoming media stream of video-based data 348 that is associated with media content of the video chat session, between end-users. In this case, central multi-media program 128, monitors, detects, and subsequently, converts media content of video-based data 348 of “Big Bank theory” to uniform resource identifiers (URIs), for display of “Big Bank theory” as an internet movie database (IMDB) page for “The Big Bang Theory” television (TV) show, wherein the “Big Bang Theory” TV show” is detected as a related media content of the video chat session, between end-users, all within, multi-media system 100.

For example, the “Big Bank Theory” is perhaps discussed during the video chat session as an error between the end users, as such, central multi-media program 128 detected the error and, identified “Big Bank Theory” as “Big Bang Theory”, for display of “Big Bang Theory” in subtitle display module 340 of IMDB page. In another embodiment, the URL of the IMDB page, can be further displayed as a clickable URL link to a web page, or an internet website, in subtitle display module 340, wherein, the internet website provides details about the most current show, in this case, “Big Bang Theory”, which is discussed during the chat sessions by the end-users of external multi-media program 124.

FIG. 3D is a functional block diagram illustrating interaction of display of subtitles of client media computing devices 108, 110, and central media server system 126, wherein a voice to text conversion of a text-based data, a voice-based data, and a video-based data of an incoming media stream from external media server system 118, is performed, in accordance with embodiments of the present invention.

As described, the incoming media stream is monitored, and detected, by central multi-media program 128 of central media server system 126. The analyzed data is metadata, including, for example, identified tags of media content of a text-based data, a voice-based data, or a video-based data of the incoming media stream. As depicted, central multi-media program 128 performs a voice to text conversion of the text-based data, the voice-based data, or the video-based data of the incoming media stream. For instance, during the voice to text conversion, the central multi-media program 128 identifies media content of the text-based data, the voice-based data, or the video-based data of the incoming media stream, wherein the media content is converted to URIs.

The identified and, converted multi-media content is transmitted, by central multi-media program 128, to client media computing devices 106, 110, for display of the identified and, converted multi-media content, in subtitles player 340. According to at least one embodiment, display of the subtitles can be in the form of a stream text. For instance, streaming text format is the text-based subtitle format for Moving Picture Experts Group (MPEG). MPEG is a standard for defining compression of audio and visual (AV) digital data in multi-media computing devices.

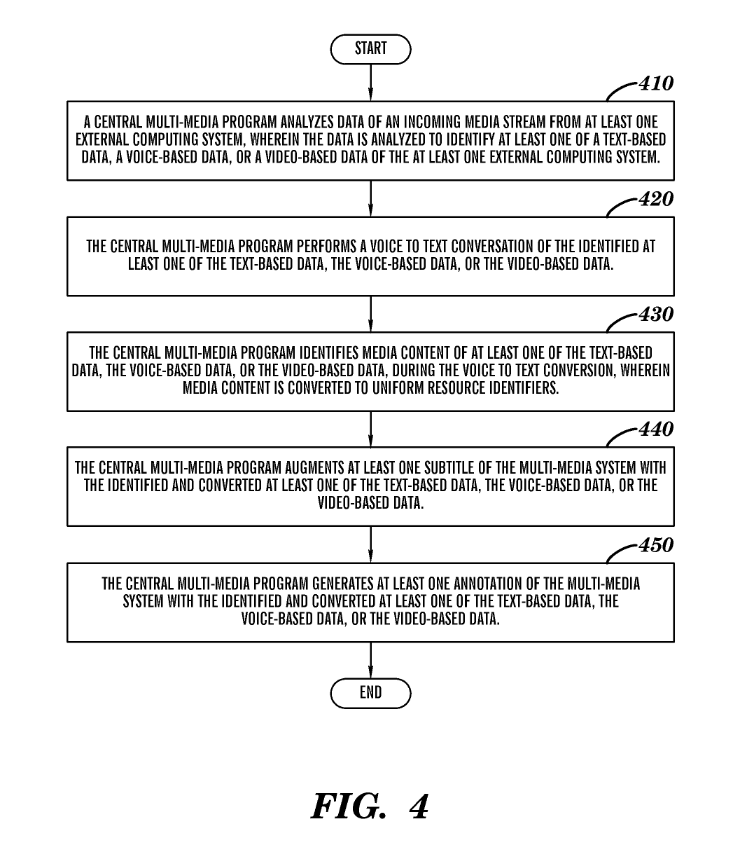

FIG. 4 is a flow diagram depicting steps performed by central multi-media program 128 for displaying incoming stream of media content, external multi-media server system 118, in subtitles display module 340, of client multi-media computing devices 106, 108, 110, in accordance with embodiments of the present invention.

Central multi-media program 128 analyzes data of an incoming media stream from external multi-media server system 118, wherein the data is analyzed to identify at least one of a text-based data, a voice-based data, or a video-based data of external multi-media server system 118 (Step 410). For example, the analyzed data is associated with real-time or streaming media of client multi-media devices 106, 108, 110. The analyzed data is also metadata, including, for example, identified tags of media content of a text-based data, a voice-based data, or a video-based data of the incoming media stream. For instance, according to at least one embodiment, topics of the incoming media stream that are associated with the real-time streaming media content of multi-media devices 106, 108,110, are identified, by central multi-media program 128, in the metadata.

As described, the analyzed data of incoming media stream includes, for example, detected data of social media sources, dictionaries, news media sources, or other external media sources, which are included in the text-based data, the voice-based data, or the video-based data of the incoming media stream of external multi-media server system 118. The analyzed data of the incoming media stream can also include graphical logos, or representation of entities, companies, products, etc. The topics are discussed, during a chat session of multi-media devices 106, 108, 110, wherein media contents of the incoming stream of external multi-media server system 118 are monitored and, detected, to determine whether the discussed topics during the chat sessions are associated with the incoming media stream from external computing devices.

Central multi-media program 128 further performs a voice to text conversion f the identified at least one of the text-based data, the voice-based data, or the video-based data. (Step 420). During the voice to text conversion, central multi-media program 128 identifies media content of the text-based data, the voice-based data, or the video-based data of the incoming media stream, wherein the media content is converted to uniform resource identifiers (URIs). Central multi-media program 128 further extracts additional media content of the text-based data, the voice-based data, or the video-based data, and correlates the extracted additional media content with the initially analyzed metadata of the text-based data, the voice-based data, or the video-based data, for the purpose of further extending, terms, keywords, or topics, discussed, identified, detected, or mentioned in media content of the incoming media stream.

Central multi-media program 128 further identifies media content of at least one of the text-based data, the voice-based data, or the video-based data, during the voice to text conversion, wherein media content is converted to URIs. (Step 430). Central multi-media program 128 also augments at least one subtitle of subtitles display module 340, with the identified and converted at least one of the text-based data, the voice-based data, or the video-based data. (Step 440). Also, central multi-media program 128 generates at least one annotation of subtitles display module 340 of client multi-media computing devices 106, 108, 110, with the identified and converted at least one of the text-based data, the voice-based data, or the video-based data. (Step 450).

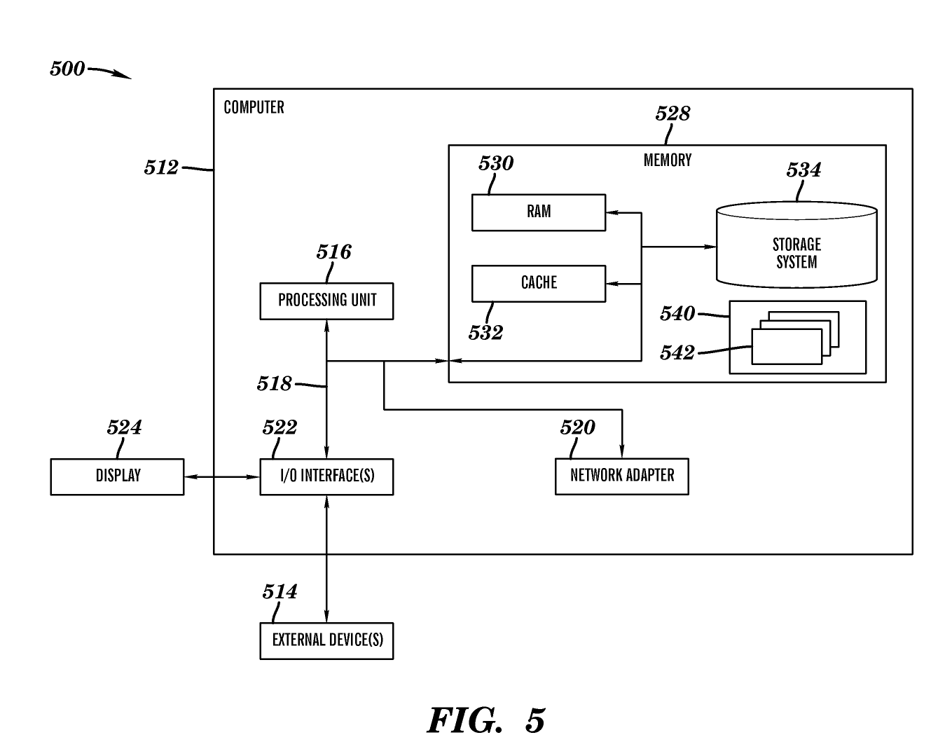

FIG. 5 is a functional block diagram of a computer system, in accordance with an embodiment of the present invention.

Computer system 500 is only one example of a suitable computer system and is not intended to suggest any limitation as to the scope of use or functionality of embodiments of the invention described herein. Computer system 500 is capable of being implemented and/or performing any of the functionality set forth hereinabove. In computer system 500 there is computer 512, which is operational with numerous other general purpose or special purpose computing system environments or configurations. Examples of well-known computing systems, environments, and/or configurations that may be suitable for use with computer 512 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each one of multi-media computing devices 106, 108, 110, external media server system 118, database storage 114 and, central media server system 126 can include or can be implemented as an instance of computer 512.

Computer 512 may be described in the general context of computer system executable instructions, such as program modules, being executed by a computer system. Generally, program modules may include routines, programs, objects, components, logic, data structures, and so on that perform particular tasks or implement particular abstract data types. Computer 512 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 5, computer 512 is shown in the form of a general-purpose computing device. The components of computer 512 may include, but are not limited to, one or more processors or processing units 516, memory 528, I/O interface 522, and bus 518 that couples various system components including memory 528 to processing unit 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 512 typically includes a variety of computer system readable media. Such media may be any available media that is accessible by computer 512, and includes both volatile and non-volatile media, and removable and non-removable media.

Memory 528 includes computer system readable media in the form of volatile memory, such as random access memory (RAM) 530 and/or cache 532. Computer 512 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the invention.

Central multi-media program 128, client multi-media program 120, external multi-media program 124 can be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the invention as described herein. Each one of central multi-media program 128, Client multi-media program 120, and external multi-media program 124 is implemented as or are an instance of program 540.

Computer 512 may also communicate with one or more external devices 514 such as a keyboard, a pointing device, etc., as well as display 524; one or more devices that enable a user to interact with computer 512; and/or any devices (e.g., network card, modem, etc.) that enable computer 512 to communicate with one or more other computing devices. Such communication occurs via Input/Output (I/O) interfaces 522. Still yet, computer 512 communicates with one or more networks such as a local area network (LAN), a general wide area network (WAN), and/or a public network (e.g., the Internet) via network adapter 520. As depicted, network adapter 520 communicates with the other components of computer 512 via bus 518. It should be understood that although not shown, other hardware and/or software components could be used in conjunction with computer 512. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations are implemented by special purpose hardware-based systems that perform the specified functions or acts, or combinations of special purpose hardware and computer instructions.

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in one or more computer-readable medium(s) having computer-readable program code embodied thereon.

In addition, any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that contains, or stores a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing. Computer program code for carrying out operations for embodiments of the present invention may be written in any combination of one or more programming languages, including an object oriented programming language such as Java, Smalltalk, C++ or the like, conventional procedural programming languages such as the “C” programming language, a hardware description language such as verilog, or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Based on the foregoing a method, system and computer program product for displaying data from external computing systems in subtitles of a multi-media system has been described. However, numerous modifications and substitutions can be made without deviating from the scope of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. Therefore, the present invention has been disclosed by way of example and not limitation.

What is claimed is:

1. A computer-implemented method for displaying data from external computing systems in subtitles of a multi-media system, the method comprising the steps of:
analyzing, by one or more processors, data of an incoming media stream from at least one external computing system, wherein the data is analyzed to identify at least one of a text-based data, a voice-based data, or a video-based data of the least one external computing system that is associated with a multi-media system;
performing, by the one or more processors, voice to text conversion of the identified at least one of the text-based data, the voice-based data, or the video-based data;
identifying, by the one or more processors, media content of at least one of the text-based data, the voice-based data, or the video-based data, during the voice to text conversion, wherein media content is converted to uniform resource identifiers;
augmenting, by the one or more processors, at least one subtitle of the multi-media system with the identified and converted at least one of the text-based data, the voice-based data, or the video-based data; and
generating, by the one or more processors, at least one annotation of the multi-media system with the identified and converted at least one of the text-based data, the voice-based data, or the video-based data.

2. The computer-implemented method according to claim 1, wherein the analyzed data of incoming media stream includes data of at least one social media source of the external computing system, and wherein the at least one subtitle of the multi-media system, and the generated annotation of the multi-media system includes the analyzed data of the at least one social media source.

3. The computer-implemented method of claim 1, further comprises the steps of:
identifying, by the one or more processors, a logotype graphical representation of an entity, wherein the logotype graphical representation is included in the media content during the voice to text conversion; and
converting, by the one or more processors, the logotype graphical representation to uniform resource identifiers of the entity, wherein the uniform resource identifiers of the entity include at least one of a product identity, or commercial offerings of the entity.

4. The computer-implemented method of claim 3, wherein the uniform resource identifiers of the entity are displayed in at least one subtitle of the multi-media system, and wherein the uniform resource identifiers of the entity are accessible, via a click, in the display of the at least one subtitle of the multi-media system.

5. The computer-implemented method of claim 1, wherein augmentation of the at least one subtitle of the multi-media system is at least one of a text display, or a visual display of the identified and converted at least one of the text-based data, the voice-based data, or the video-based data of the at least one subtitle of the multi-media system.

6. The computer-implemented method of claim 1, wherein the analyzing step, further comprises the steps of:
extracting, by the one or more processors, tags, of the data of the incoming media stream that are associated with the multi-media system, wherein the tags includes at least one of media content of the least one of text-based data, the voice-based data, or the video-based data of the least one external computing system;
recording, by the one or more processors, in a repository of the multi-media system, time, date, and location of the data of the incoming media stream of the at least one external computing system, wherein the repository includes searchable data, including, media content of data of the incoming media stream from the at least one or more external computing system; and
recording, by the one or more processors, in the repository of the multi-media system, identity of the data of the incoming media stream of the at least one external computing system, wherein the identity includes, at least one of a creator, or owner of the data of the incoming media stream.

7. The computer-implemented method of claim 6, wherein the time, date, and location of the data of the incoming media stream includes an identification of time, date, and location of the incoming media stream data creation, and wherein the identification of time, date, and location of the incoming media stream data creation is displayed in at least one subtitle of the multi-media system.

8. A computer system for displaying data from external computing systems in subtitles of a multi-media system, the computer system comprises:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to analyze data of an incoming media stream from at least one external computing system, wherein the data is analyzed to identify at least one of a text-based data, a voice-based data, or a video-based data of the least one external computing system that is associated with a multi-media system;
program instructions to perform voice to text conversion of the identified at least one of the text-based data, the voice-based data, or the video-based data;
program instructions to identify media content of at least one of the text-based data, the voice-based data, or the video-based data, during the voice to text conversion, wherein media content is converted to uniform resource identifiers;
program instructions to augment at least one subtitle of the multi-media system with the identified and converted at least one of the text-based data, the voice-based data, or the video-based data; and
program instructions to generate at least one annotation of the multi-media system with the identified and converted at least one of the text-based data, the voice-based data, or the video-based data.

9. The computer system of claim 8, wherein the analyzed data of incoming media stream includes data of at least one social media source of the external computing system, and wherein the at least one subtitle of the multi-media system, and the generated annotation of the multi-media system includes the analyzed data of the at least one social media source.

10. The computer system of claim 8, further comprises:
program instructions to identify a logotype graphical representation of an entity, wherein the logotype graphical representation is included in the media content during the voice to text conversion; and
program instructions to convert the logotype graphical representation to uniform resource identifiers of the entity, wherein the uniform resource identifiers of the entity include at least one of a product identity, or commercial offerings of the entity.

11. The computer system of claim 10, wherein the uniform resource identifiers of the entity are displayed in at least one subtitle of the multi-media system, and wherein the uniform resource identifiers of the entity are accessible, via a click, in the display of the at least one subtitle of the multi-media system.

12. The computer system of claim 8, wherein augmentation of the at least one subtitle of the multi-media system is at least one of a text display, or a visual display of the identified and converted at least one of the text-based data, the voice-based data, or the video-based data of the at least one subtitle of the multi-media system.

13. The computer system of claim 8, further comprises:
program instructions to extract tags, of the data of the incoming media stream that are associated with the multi-media system, wherein the tags includes at least one of media content of the least one of text-based data, the voice-based data, or the video-based data of the least one external computing system;
program instructions to record in a repository of the multi-media system, time, date, and location of the data of the incoming media stream of the at least one external computing system, wherein the repository includes searchable data, including, media content of data of the incoming media stream from the at least one or more external computing system; and
program instructions to record, in the repository of the multi-media system, identity of the data of the incoming media stream of the at least one external computing system, wherein the identity includes, at least one of a creator, or owner of the data of the incoming media stream.

14. The computer system of claim 13, wherein the time, date, and location of the data of the incoming media stream includes an identification of time, date, and location of the incoming media stream data creation, and wherein the identification of time, date, and location of the incoming media stream data creation is displayed in at least one subtitle of the multi-media system.

15. A computer program product for displaying data from external computing systems in subtitles of a multi-media system, the computer program product comprises:
one or more computer-readable tangible storage devices and program instructions stored on at least one of the one or more storage devices, the program instructions comprising:
program instructions to analyze data of an incoming media stream from at least one external computing system, wherein the data is analyzed to identify at least one of a text-based data, a voice-based data, or a video-based data of the least one external computing system that is associated with a multi-media system;
program instructions to perform voice to text conversion of the identified at least one of the text-based data, the voice-based data, or the video-based data;
program instructions to identify media content of at least one of the text-based data, the voice-based data, or the video-based data, during the voice to text conversion, wherein media content is converted to uniform resource identifiers;
program instructions to augment at least one subtitle of the multi-media system with the identified and converted at least one of the text-based data, the voice-based data, or the video-based data; and
program instructions to generate at least one annotation of the multi-media system with the identified and converted at least one of the text-based data, the voice-based data, or the video-based data.

16. The computer program product of claim 15, wherein the analyzed data of incoming media stream includes data of at least one social media source of the external computing system, and wherein the at least one subtitle of the multi-media system, and the generated annotation of the multi-media system includes the analyzed data of the at least one social media source.

17. The computer program product of claim 15, further comprises:
program instructions to identify a logotype graphical representation of an entity, wherein the logotype graphical representation is included in the media content during the voice to text conversion; and
program instructions to convert the logotype graphical representation to uniform resource identifiers of the entity, wherein the uniform resource identifiers of the entity include at least one of a product identity, or commercial offerings of the entity.

18. The computer program product of claim 17, wherein the uniform resource identifiers of the entity are displayed in at least one subtitle of the multi-media system, and wherein the uniform resource identifiers of the entity are accessible, via a click, in the display of the at least one subtitle of the multi-media system.

19. The computer program product of claim 15, wherein augmentation of the at least one subtitle of the multi-media system is at least one of a text display, or a visual display of the identified and converted at least one of the text-based data, the voice-based data, or the video-based data of the at least one subtitle of the multi-media system.

20. The computer program product of claim 8, further comprises:
program instructions to extract tags, of the data of the incoming media stream that are associated with the multi-media system, wherein the tags includes at least one of media content of the least one of text-based data, the voice-based data, or the video-based data of the least one external computing system;
program instructions to record in a repository of the multi-media system, time, date, and location of the data of the incoming media stream of the at least one external computing system, wherein the repository includes searchable data, including, media content of data of the incoming media stream from the at least one or more external computing system; and
program instructions to record, in the repository of the multi-media system, identity of the data of the incoming media stream of the at least one external computing system, wherein the identity includes, at least one of a creator, or owner of the data of the incoming media stream.
